(19) United States
(12) Patent Application Publication
(10) Pub. No.: US 2026/0320813 A1
(43) Pub. Date: Oct. 15, 2026

(54) SYSTEM AND METHOD FOR AUTOMATICALLY MEASURING SECTIONAL PROFILE OF OBJECT

(71) Applicant: The University of Hong Kong, Pokfulam (CN)

(72) Inventors: Kai Leung Su, Pokfulam (CN); Chaobin Li, Pokfulam (CN); Zhongxu Zhao, Pokfulam (CN)

(21) Appl. No.: 19/456,236

(22) Filed: Jan. 22, 2026

(30) Foreign Application Priority Data
Feb. 19, 2025 (CN) 202510185250.5

(51) Int. Cl. G06T 7/521; G01B 11/30; G06T 5/80; G06T 7/11; G06T 7/80

(52) U.S. Cl. CPC G06T 7/521; G01B 11/30; G06T 5/80; G06T 7/11; G06T 7/80; G06T 2207/10028

(57) ABSTRACT

The present invention discloses a system and method for automatically measuring a sectional profile of an object. The present invention also discloses a non-transitory computer-readable medium storing computer-readable instructions for the system. The system includes: a single-line laser configured to emit a single laser line; at least one mirror configured to reflect the laser line onto at least one non-exposed surface of a target object to be measured; a camera configured to capture distortion of the laser line projected onto a surface of the target object; and an image processing unit configured to process the distortion captured by the camera to generate the sectional profile of the target object. The system of the present invention improves accuracy, repeatability and efficiency through automated measurement and can become a highly efficient tool for applications requiring precise sectional profile analysis of irregular and inaccessible surfaces.

### TECHNICAL FIELD

The present invention relates to a system and method for automatically measuring a sectional profile of an object. The present invention also relates to a non-transitory computer-readable medium storing computer-readable instructions for the system.

### BACKGROUND

Accurate measurement of a sectional profile of an irregular object is critical. Existing sectional measurement methods mainly have the following problems: 1. Simple manual instruments such as calipers are used to perform measurement. Calipers are confined to measuring only maximum and minimum dimensions of a profile, which usually depends on personal experience and exhibits poor repeatability, and caliper measurement cannot accurately predict the detailed dimensions of the sectional profile. 2. Existing 3D laser scanners commercially available on the market are often very expensive, and the process building accurate models using these devices is time-consuming. In addition, these methods typically require the rotation of either the measurement device or the object being measured, which introduces significant inconvenience and can render the measurement process impossible in certain scenarios, such as when measuring the sectional profile of trees where the object may be stationary or inaccessible to rotation. Therefore, when sectional dimensions are relatively small or when the portion surface of an object is not visible, existing measurement methods become challenging and even impossible. For instance, measuring the sectional profile of corroded rebar after detachment of a concrete ceiling is difficult because the backside section of the corroded rebar is inaccessible.

Existing instruments usually lack an ability to perform high precision measurements while maintaining cost effective.

It should be noted that the information disclosed in the above Background section is only for understanding the background of the present application and thus may include information that does not constitute prior art known to those of ordinary skill in the art.

### SUMMARY OF THE INVENTION

The present invention provides a system and method for automatically measuring a sectional profile of an object, which simultaneously possesses advantages such as low cost, convenience, and measurement accuracy.

The present invention adopts the following technical solutions:

In a first aspect, provided is a system for automatically measuring a sectional profile of an object, comprising: a single-line laser, configured to emit a single laser line; at least one mirror, configured to reflect the laser line onto at least one non-exposed surface of a target object to be measured; a camera, configured to capture distortion of the laser line projected onto a surface of the target object; and an image processing unit, configured to process the distortion captured by the camera to generate the sectional profile of the target object.

In a second aspect, provided is a method for automatically measuring a sectional profile of an object, comprising the following steps: S1. emitting a single laser line using a single-line laser; S2. reflecting the laser line onto at least one non-exposed surface of a target object to be measured via at least one mirror; S3. capturing distortion of the laser line projected onto a surface of the target object using a camera; and S4. processing the distortion captured by the camera via an image processing unit to generate sectional profile of the target object.

In a third aspect, provided is a non-transitory computer-readable medium storing computer-readable instructions for a system for automatically measuring a sectional profile of an object, wherein the storing computer-readable instructions, when executed by a processor of the system, cause the processor to: emit a single laser line using a single-line laser; reflect the laser line onto at least one non-exposed surface of a target object to be measured via at least one mirror; capture distortion of the laser line projected onto a surface of the target object using a camera; and process the distortion captured by the camera via an image processing unit to generate sectional profile of the target object.

Beneficial effects of the present invention include: The system of the present invention is a portable single-line laser scanning system based on a laser triangulation principle. This system is specifically tailored for automated and precise measurement of irregular sectional profiles of objects, achieving an error less than 0.1 mm, and has the following advantages:
1. Compared to calipers, the present invention can measure sectional profile dimensions of irregular objects having non-exposed surfaces, offering higher accuracy. The system of the present invention allows for comprehensive profile analysis without the need for direct access to all surfaces of the object, thereby overcoming limitations inherent in conventional caliper-based measurements.
2. In comparison to market-available 3D laser scanners, the present invention is more cost-effective, rapid, and convenient. Unlike traditional 3D laser scanning methods, which often require the rotation of either the measurement device or the object to capture complete sectional data, the present invention eliminates the need for such rotations. This is accomplished by installing mirrors at a position corresponding to the non-exposed surface of the target object, which reflect the laser onto previously inaccessible non-exposed surface, and relative rotation between the object and the device is not required. The present invention facilitates identification and measurement of the sectional profiles without the logistical complexities and time delays associated with rotating the object or scanning equipment, making the measurement process of the present invention more efficient and user-friendly.
3. The present invention incorporates advanced machine learning algorithms into its image processing pipeline to accurately locate object surfaces, extract the center of the laser stripe, and minimize errors induced by image distortion. By leveraging these sophisticated computational techniques, the present invention ensures high accuracy in measuring irregular objects, thereby providing reliable and detailed sectional profiles that surpass capabilities of existing measurement solutions.
4. The present invention exhibits remarkable flexibility and effectiveness in non-perpendicular scenarios. Even when the object and the laser plane are not aligned perpendicularly, the present invention can generate accurate sectional profiles.
5. The system of the present invention is also simple, portable, flexible, and economical, and can provide an attractive solution for industries seeking reliable, easy-to-use, and cost-effective measurement technologies.
6. The system of the present invention can capture an entire sectional shape of an object without requiring rotation thereof.
7. The system of the present invention can rapidly calculate the sectional profile without requiring a coordinate measurement device. In addition, the system of the present invention only requires a simple, lower-power, non-contact, and lightweight setup, possessing strong practicality, and thus is very suitable for autonomous robot inspection and next-generation smart condition assessment. The system of the present invention ensures easy integration into robotic platforms and supports efficient, real-time monitoring and evaluation of object conditions without needing complex or energy-consuming equipment.

In summary, the system of the present invention improves accuracy, repeatability, and efficiency through automated measurement, and making it a highly efficient tool for applications requiring precise sectional profile analysis of irregular and inaccessible surfaces.

### BRIEF DESCRIPTION OF THE DRAWINGS

FIG. 1a is a front view of a measurement scenario of a system for automatically measuring a sectional profile of an object in an embodiment of the present invention;

FIG. 1b is a side view of the measurement scenario of the system for automatically measuring a sectional profile of an object in an embodiment of the present invention;

FIG. 1c is a laser image captured by a digital camera in the measurement scenario of the system for automatically measuring a sectional profile of an object in an embodiment of the present invention;

FIG. 2 is a schematic diagram of a single laser arc length on a surface of a target object captured by a camera in an embodiment of the present invention;

FIG. 3 is a schematic diagram of performing sectional profile measurement in an embodiment of the present invention;

FIG. 4 is a flowchart of performing sectional profile measurement in an embodiment of the present invention;

FIG. 5 is a flowchart of stripe center extraction in an embodiment of the present invention;

FIG. 6 shows a 3D measurement model when (a) the laser projects on an exposed surface of the object directly and (b) the laser projects on a non-exposed surface of the object indirectly in an embodiment of the present invention;

FIG. 7 is a schematic diagram of an experimental setup of a laser scanning apparatus in an embodiment of the present invention;

FIG. 8 shows (a) an external perspective view and (b) an internal perspective view of a physical experimental setup of a laser scanning apparatus in an embodiment of the present invention;

FIG. 9 is a schematic diagram of validation of experimental results using a standard cylinder in an embodiment of the present invention;

FIG. 10 is a parameter design schematic diagram of placement position of a mirror in an embodiment of the present invention.

### DETAILED DESCRIPTION OF THE PREFERRED EMBODIMENTS

Embodiments of the present invention will be described in detail below. It should be emphasized that the following description is merely illustrative and is not intended to limit the scope of the present invention and its application. The embodiments in the present application and features in the embodiments may be combined with each other without conflict.

Current measurement technologies available on the market usually do not support automated measurement of sectional profile dimensions for non-exposed surfaces. When dealing with objects having inaccessible or concealed areas (such objects have non-exposed surfaces), traditional methods fail to capture comprehensive dimensional data of the entire section. Therefore, specific embodiments of the present invention provide a system for automatically measuring a sectional profile of an object, comprising:
a single-line laser, configured to emit a single laser line;
at least one mirror, configured to reflect the laser line onto at least one non-exposed surface of a target object to be measured;
a camera, configured to capture distortion of the laser line projected onto a surface of the target object; and
an image processing unit, configured to process the distortion captured by the camera to generate the sectional profile of the target object.

In some embodiments, the target object comprises three uneven surfaces, which are an exposed surface, a first non-exposed surface, and a second non-exposed surface respectively; the mirror comprises a first mirror and a second mirror, wherein the first mirror corresponds to the first non-exposed surface such that the first non-exposed surface forms a first virtual image in the first mirror, and the second mirror corresponds to the second non-exposed surface such that the second non-exposed surface forms a second virtual image in the second mirror; the laser line emitted by the single-line laser: projects directly onto the exposed surface, projects onto the first non-exposed surface via the first mirror, and projects onto the second non-exposed surface via the second mirror; the camera is configured to capture the exposed surface, the first virtual image, and the second virtual image so as to capture the distortion of the laser line projected onto the three uneven surfaces; and the image processing unit is configured to reconstruct a 3D profile of each surface based on the distortion, and superimpose the laser profiles of the three uneven surfaces, thereby generating a complete sectional profile of the target object.

Herein, observed from an angle outside a direct emission path of the single-line laser, a surface directly accessible by the laser is the exposed surface, and a surface that cannot be directly illuminated by the laser is the non-exposed surface. For example, a front face of the target object to be measured is the exposed surface, and a face on a rear side is the non-exposed surface.

In some embodiments, the laser line emitted by the single-line laser: projects directly onto the exposed surface to form a third laser arc length on the exposed surface, projects onto the first non-exposed surface via the first mirror to form a first laser arc length on the first virtual image, and projects onto the second non-exposed surface via the second mirror to form a second laser arc length on the second virtual image; the camera is configured to capture the first laser arc length, the second laser arc length, and the third laser arc length; and the image processing unit is configured to superimpose arc lengths of the three laser arc lengths, thereby generating the complete sectional profile of the target object.

In some embodiments, the first mirror and the second mirror are positioned on oblique rear sides of the target object to form a V-shaped configuration relative to the target object such that the camera captures the exposed surface and the virtual images of the first and second non-exposed surfaces in a single image frame without rotating the system around the target object.

In some embodiments, a light source of the single-line laser is a laser diode.

In some embodiments, the single-line laser and the camera are aligned along the same vertical axis.

In some embodiments, the single-line laser, the mirror and the camera are rigidly fixed relative to each other.

In some embodiments, the system further comprises a rod configured to rigidly mount the single-line laser, the mirror and the camera.

In some embodiments, the image processing unit comprises:
a distortion correction module configured to perform correction on the distortion;
an image segmentation module configured to segment a laser stripe from an image after correction;
a stripe center extraction module configured to extract a sub-pixel center of the laser stripe;
a 3D point cloud generation module configured to aggregate sub-pixel centers of the laser stripe to generate a 3D point cloud;
a sectional profile reconstruction module configured to extract the sectional profile from the 3D point cloud.

In some embodiments, the 3D point cloud generation module is configured to calculate real-world spatial coordinates of the non-exposed surface by determining an intersection point between vector of the camera and a plane of the mirror and applying a reflection symmetry transformation to the sub-pixel center of the laser stripe.

In some embodiments, a placement position of the mirror satisfies following condition:

$${L}_{M} \geq \frac{{D}_{max}}{2 sin θ}$$

wherein an extended line of a connecting line between a center of the target object and a center of the single-line laser intersects with an extended line of the mirror at a point P₁, L_{M} represents the distance between the point P₁ and an initial point of the mirror M, θ represents an included angle between the extended line of the connecting line and the extended line of the mirror, and Dₘₐₓ represents a maximum equivalent circular diameter of the target object.

In some embodiments, the target object is a reinforcement bar partially embedded in a concrete structure.

A specific embodiment of the present invention further provides a method for automatically measuring a sectional profile of an object, comprising the following steps:
S1. emitting a single laser line using a single-line laser;
S2. reflecting the laser line onto at least one non-exposed surface of a target object to be measured via at least one mirror;
S3. capturing distortion of the laser line projected onto a surface of the target object using a camera; and
S4. processing the distortion captured by the camera via an image processing unit to generate the sectional profile of the target object.

In some embodiments, the method further comprises the following step of: positioning the at least one mirror relative to the target object such that the single laser line illuminates at least 75% of the entire section of the target object.

In some embodiments, the method further comprises, prior to step S1, the following calibration step of: determining a relative spatial position and orientation of the camera, the single-line laser, and the at least one mirror to establish a measurement model for correlating 2D pixel coordinates of the camera to 3D spatial coordinates.

In some embodiments, step S4 comprises:
S41. performing correction on the distortion;
S42. segmenting a laser stripe from an image after correction;
S43. extracting a sub-pixel center of the laser stripe;
S44. aggregating sub-pixel centers of the laser stripe to generate a 3D point cloud;
S45. extracting the sectional profile from the 3D point cloud.

In some embodiments, step S42 uses a U-Net model to segment the laser stripe; step S43 uses a Steger algorithm to extract the sub-pixel center of the laser stripe; and step S45 reconstructs the sectional profile of the target object through 3D point cloud post-processing.

In some embodiments, step S44 comprises the following steps of:
defining a normal vector of the at least one mirror;
calculating a direction vector from the camera to an observed laser point on the mirror;
determining an intersection point between the direction vector and a plane of the mirror; and
calculating an actual position of the laser point on the non-exposed surface using reflection symmetry based on the intersection point and the normal vector.

In some embodiments, step S45 comprises the following step of:
applying a minimization algorithm to optimize an alignment of the 3D point cloud derived from the exposed surface and the 3D point cloud derived from the non-exposed surface to minimize residual errors between a modeled profile and empirical data points.

A specific embodiment of the present invention further provides a non-transitory computer-readable medium storing computer-readable instructions for a system for automatically measuring a sectional profile of an object, wherein the storing computer-readable instructions, when executed by a processor of the system, cause the processor to:
emit a single laser line using a single-line laser;
reflect the laser line onto at least one non-exposed surface of a target object to be measured via at least one mirror;
capture distortion of the laser line projected onto a surface of the target object using a camera; and
process the distortion captured by the camera via an image processing unit to generate sectional profile of the target object.

Reinforced concrete (RC) has always been the most commonly used structural material worldwide, and rebar corrosion is a major cause of premature deterioration of RC structures. Due to high maintenance and replacement costs, accurate structural inspection and RC deterioration prediction are critical for formulating effective measures to eliminate corrosion problems and ensuring optimal allocation of limited resources. The present invention is described in detail below taking measurement of a sectional profile of a corroded rebar after detachment of a concrete ceiling as an example.

### 1. Measurement Principle

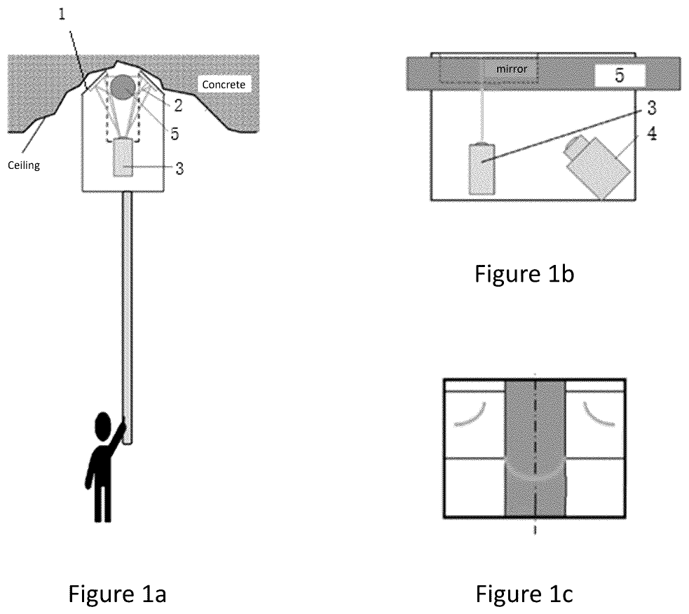

The system comprises a laser scanning apparatus and an image processing unit that provide measurement results through laser triangulation. The laser scanning apparatus comprises a single-line laser using a line laser diode 3 projecting a single laser line as a light source, a camera 4, and two mirrors (a first mirror 1 and a second mirror 2). As shown in FIGS. 1a-1c, considering measurement of a sectional profile of a ceiling rebar, the line laser diode 3 and the camera 4 are aligned along the same vertical axis, and the two mirrors 1, 2 are positioned on oblique rear sides of a target object 5 (rebar in this example).

In this preferred embodiment, the first mirror 1 and the second mirror 2 are arranged in a V-shaped configuration relative to the target object 5. The mirrors are angled such that they open towards the single-line laser 3 and the camera 4. This specific V-shaped geometry allows the laser line to pass between the mirrors to directly strike the exposed surface of the target object, while simultaneously allowing the mirrors to intercept the laser line as it passes the object and reflect it onto the non-exposed rear surfaces. Consequently, the camera 4, positioned along the central axis of this V-shape, can capture the direct view of the exposed surface and the reflected virtual images of the non-exposed surfaces within a single image frame (a single shot), thereby eliminating the need to rotate the system around the target object.

The two mirrors placed at key positions are configured to facilitate reflection and projection of the laser onto non-exposed surfaces of the target object. During scanning, observation is performed from an angle outside a direct emission path of the laser diode. A beam emitted by the laser diode directly illuminates a front surface (exposed surface) of the irregular object and is projected onto two inclined rear surfaces (two non-exposed surfaces) through mirror reflection, thereby causing the single laser line to distort across three uneven surfaces. The camera photographs the exposed surface and virtual images of the two non-exposed surfaces reflected in the mirrors to capture distortion of the single laser line on the three uneven surfaces (in this example, including a front face and two non-exposed side faces of the target object). The laser diode used in this embodiment is a Class I laser (power less than 0.4 MW) and conforms to 21 CFR 1040.10 and 1040.11. For image processing, a U-Net model is adopted for laser stripe segmentation. A sub-pixel center of the detected laser stripe is extracted by a Steger algorithm and then aggregated to generate a 3D point cloud based on an image model (3D measurement model) and the sectional profile is extracted from the 3D point cloud. This advanced scanning method enhances accuracy and reliability of profiling the irregular object, thereby providing an economical and practical alternative to existing measurement tools.

In one example embodiment, the system may be configured as a handheld portable device where the single-line laser, the mirror and the camera can be rigidly fixed relative to each other. For instance, the system may further comprise a handheld positioning rod connected to the system to facilitate manual positioning of the system relative to the target object.

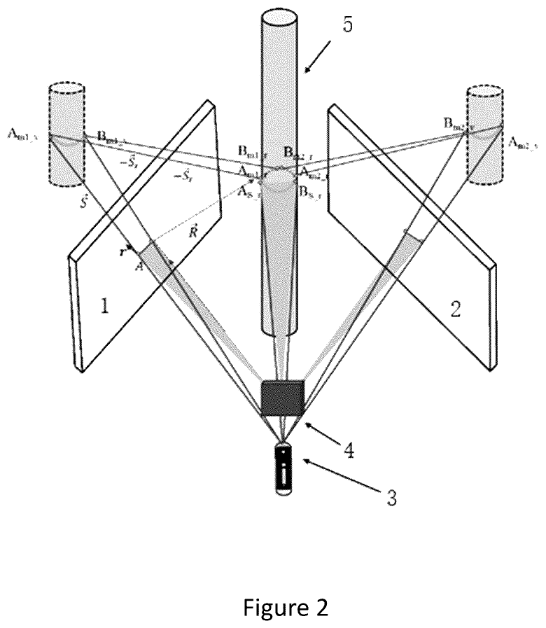

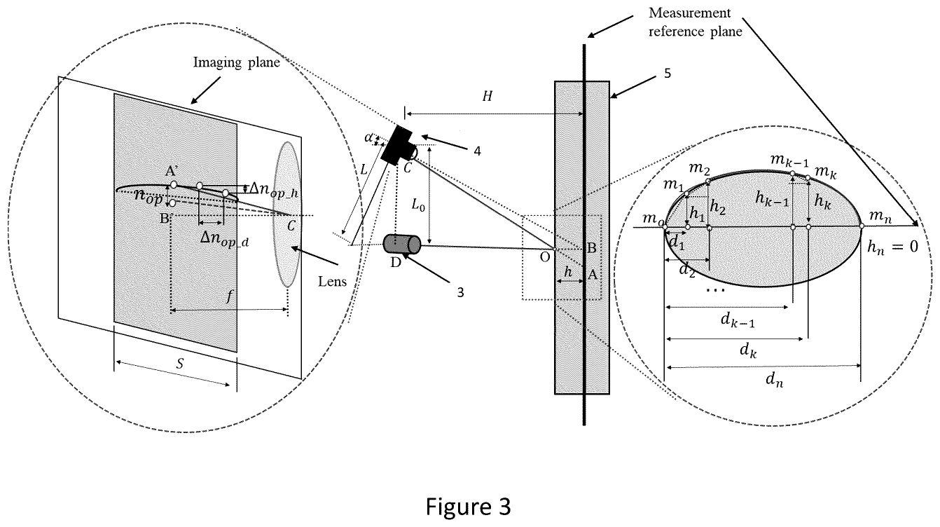

FIGS. 2 and 3 illustrate the measurement principle, which demonstrates sectional profile measurement using the laser scanning apparatus. As shown in FIG. 2, a process by which the camera captures a laser point A_{m1_r} through positioning of the mirror involves the following steps in Table 1:

TABLE 1
Pseudocode for Laser Point Localization via Mirror Positioning

Step 1: Define the mirror's normal vector \vec{r}
normal vector = \vec{r}
Step 2: Assign the observed laser point on the mirror surface
Aₘ₁_v = X
Step 3: Compute the direction vector \vec{R} from the camera to Aₘ₁_v
\vec{R}= Normalize(Aₘ₁_v − CameraPosition)
Step 4: Determine the intersection point A between vector \vec{R} and the
mirror plane
A = CalculateIntersection(R, MirrorPlane)
Step 5: Define vector \vec{S} from point A to the observed laser point Aₘ₁_v
\vec{S} = Aₘ₁_v − A
Step 6: Decompose vector S along the normal vector r to obtain \vec{S}ᵣ
Sr_magnitude = DotProduct(\vec{S},\vec{r})
\vec{S}ᵣ = Sr_magnitude × \vec{r}
Step 7: Calculate the actual position of Aₘ₁_v using the reflection
symmetry Aₘ₁_r = X − (2 × \vec{S}ᵣ)

Based on the above equations, the camera 4 directly captures a laser arc length on the exposed surface (the front face in this example) of the target object 5, denoted as arc length A_{s_}rB_{s_}r. The laser is also projected onto the non-exposed surfaces (the two rear side faces in this example) of the target object via the mirrors, thereby generating arc lengths A_{m1_v}B_{m1_v} and A_{m2_v}B_{m2_v} on the virtual images formed in the mirrors, which are subsequently captured by the camera. The laser reflects off surfaces of the mirrors and projects onto the non-exposed surfaces of the target object, thereby generating arc lengths A_{m1_r}B_{m1_r} and A_{m2_r}B_{m2_r}. Assuming that the mirrors are perpendicular to a laser plane, the virtual images of the non-exposed surfaces in the mirrors have arc lengths equal to arc lengths of the arc lengths projected by laser reflection. Specifically, arc length A_{m1_v}B_{m1_v}=A_{m1_r}B_{m1_r} and arc length A_{m2_v}B_{m2_v}=A_{m2_r}B_{m2_r}. The camera captures three different arc lengths: A_{s_}rB_{s_}r, A_{m1_v}B_{m1_v}, and A_{m2_v}B_{m2_v}. By overlaying these arc lengths, the sectional profile of the target object can be obtained accurately.

As shown in FIG. 3, in this example, a single laser is projected onto a surface of the rebar (target object 5) at point A and is imaged by a lens of the camera 4 onto an image sensor at point A′. A measurement reference plane is established on a vertical section centered on the rebar. For a point on the sectional profile of the rebar, its relative position to the reference plane causes a laser beam to project said position onto point B on the measurement reference plane. Consequently, a captured laser point on the image sensor shifts from A′ to B′. Assuming that an imaging plane is parallel to the measurement reference plane and there is no camera imaging distortion, a depth (h) of the section of the rebar at point O can be calculated based on a triangulation angle between a semiconductor laser module and the camera. Derivation of the sectional depth of the rebar is as follows:

Considering similarity of ΔOAB and ΔOCD, it can be verified that:

$$AB = \frac{L \times h}{H - h} \qquad ( 1 )$$

wherein H is a measurement distance between the camera and the measurement reference plane, and L is an equivalent horizontal distance between the camera and the laser diode, which is determined by the following formula:

$$L = \frac{{L}_{0}}{sin α} \qquad ( 2 )$$

wherein L₀ is a center distance between the camera 4 and the laser diode 3, and a is a camera inclination angle.

Similarly, considering similarity of ΔCAB and ΔCA′B′, a deformation displacement (A′B′) at the image sensor is computed as:

$${A}^{′} {B}^{′} = \frac{f}{H} \times AB \qquad ( 3 )$$

wherein f is a focal length of the camera.

The number of offset pixels (nₒₚ) is computed as:

$${n}_{op} = \frac{{A}^{′} {B}^{′} \times r}{s} \qquad ( 4 )$$

wherein r is a horizontal resolution of the image sensor, and sis a horizontal size of the image sensor.

By combining equations (1)-(4), it can be obtained:

$${n}_{op} = \frac{r \times f \times L \times h}{s \times H \times ( H - h ) \times sin α} \qquad ( 5 )$$

Equation (5) illustrates that the depth of a laser-scanned section is expressed in terms of line-distorted pixels, which can be computed using image processing techniques. Consequently, measurement sensitivity represented by nₒₚ/f reflects the ability to detect minor height variations.

In contrast to the sectional depth h, the lateral distance d of the section is directly observed and calculated. Along the laser line projected onto the rebar, multiple laser points {m₀, m₁, m₂, . . . , mₙ} are identified, with each laser point's lateral distance denoted as {d₀, d₁, d₂, . . . , dₙ} respectively. Depth distances {h₀, h₁, h₂, . . . , hₙ} of these laser points can be computed using the above formula. When the laser points are sufficiently dense, the arc length of each segment can be approximated by a hypotenuse of the corresponding triangular segment.

The approximation of a sectional length of the rebar is as follows:

$$arc {m}_{0} {m}_{n} = {\sum }_{1}^{n} \sqrt{{( {d}_{i} - {d}_{i - 1} )}^{2} + {( {h}_{i} - {h}_{i - 1} )}^{2}} \qquad ( 6 )$$

Where d₀ and hₙ are equal to zero due to m₀ and mₙ correspond to laser points located at both ends of the section

Consequently, a captured sectional laser length on the image sensor shifts as:

$$arc laser length = \sum \sqrt{{( Δ {n}_{op \_ d} )}^{2} + {( Δ {n}_{op \_ h} )}^{2}} \qquad ( 7 )$$

This approximation facilitates accurate reconstruction of the sectional profile by summing individual arc segments derived from dense laser point extraction.

### 2. Image Processing Pipeline

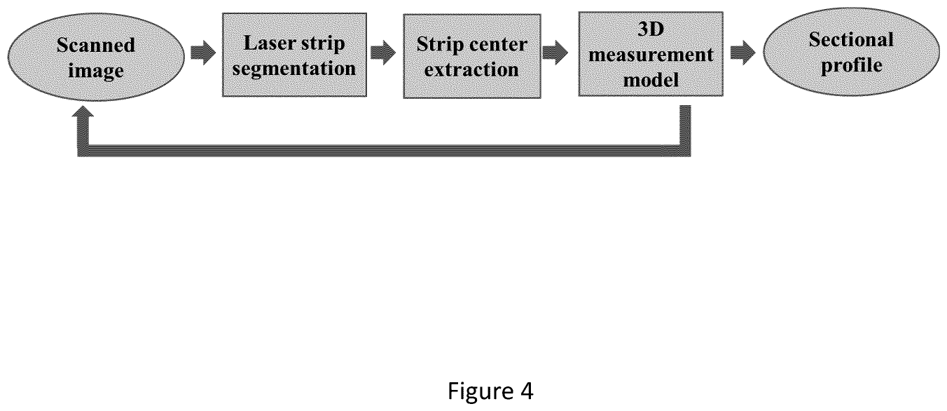

Image processing primarily focuses on extracting the center of the laser stripe from the scanned image (i.e., an image captured by the camera). By integrating a 3D measurement model, a correspondence between measurement 3D laser points and their respective image pixels is established. Subsequently, positions of the mirrors are determined to facilitate restoration and overlaying of the sectional profile. Finally, an actual sectional profile is identified. FIG. 4 illustrates a process of image processing, which employs aligned 3D laser lines to achieve precise calculation and reconstruction of the sectional profile. The methodology commences with the application of distortion correction to a laser-scanned image, utilizing distortion parameters obtained through a comprehensive camera calibration procedure. After the image is rectified, a single laser stripe is accurately identified using a U-Net convolutional neural network in an image segmentation tasks. Then, the central pixel coordinates (u, v) of the laser stripe are precisely determined using the Steger algorithm (i.e., an established method for stripe center extraction). Subsequently, an image model is utilized to establish a correlation between the central pixel coordinates (u, v) and corresponding spatial 3D point cloud coordinates (X_{c}, Y_{c}, Z_{c}). This correlation facilitates accurate transformation of pixel-based measurements into real-world spatial coordinates. Based on transformed 3D coordinates of undistorted laser points, the relative positional relationship between the camera and the measured surface is effectively defined. By integrating and overlaying multiple spatial 3D point clouds, the sectional profile of the measured object is constructed. The final sectional profile is then computed using a minimization algorithm, which optimizes alignment and accuracy of the profile by minimizing residual errors between the modeled profile and the empirical data.

Specifically, the minimization algorithm functions by fitting the aggregated 3D point clouds—derived from both the exposed surface and the virtual images of the non-exposed surfaces—to a geometric model (e.g., a circle or ellipse for rebar, or a spline for irregular shapes). The algorithm iteratively adjusts the alignment of the point clouds to minimize the root mean square (RMS) error between the measured points and the ideal geometric model. This post-processing step compensates for minor calibration inaccuracies or noise in the sub-pixel extraction, ensuring a continuous and accurate closed-loop sectional profile.

The image processing algorithm of the present invention is further described below.

### (1) Stripe Center Extraction

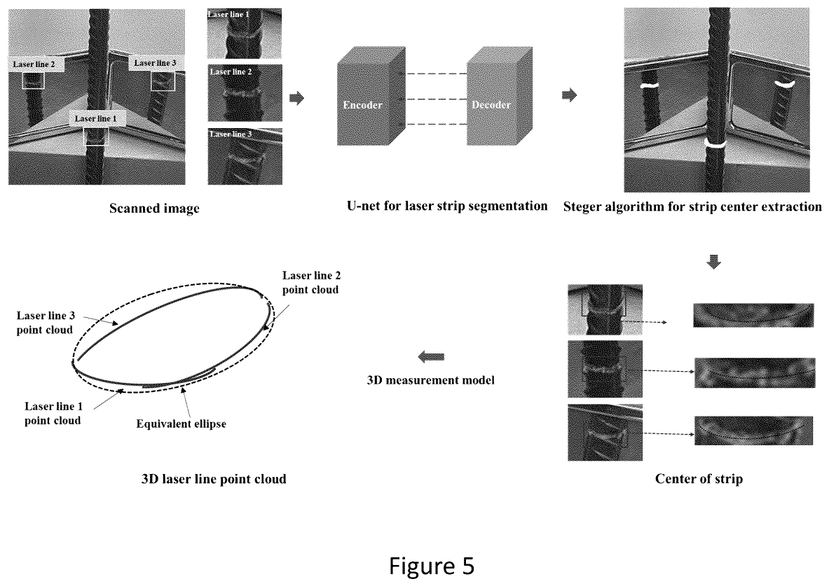

Accurate extraction of laser stripe center coordinates is crucial for capturing the profile and dimensions of an object section. To ensure efficient and robust extraction while mitigating interference, a stripe center extraction algorithm is designed based on deep convolutional neural networks (CNNs). FIG. 5 depicts a flowchart of the stripe center extraction algorithm.

### (2) 3D Measurement Model

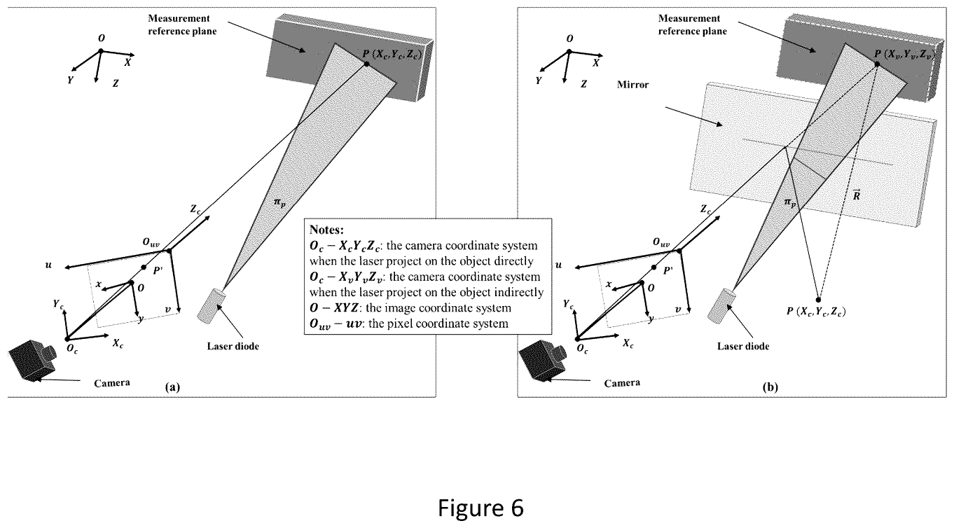

The image model establishes a relationship between a point P (X_{c}, Y_{c}, Z_{c}) in the light plane where the laser stripe is located and its corresponding image pixel coordinates P′(u, v) (shown in (a) of FIG. 6). This relationship is defined by leveraging geometric and trigonometric associations. As described above, for the non-exposed surfaces on both sides, the central pixel coordinates (u, v) are correlated with spatial 3D coordinates (Xᵥ, Yᵥ, Zᵥ) of the virtual images of the objects on the mirror surface. Using the same methodology, a separate measurement reference plane is established at the mirror location, thereby defining the mutual positional relationship between the camera and the mirror surface mirror:

$${A}_{{i}_{m}} X + {B}_{{i}_{m}} Y + {C}_{{i}_{m}} Z + {D}_{i \_ m} = 0 \qquad ( 8 )$$

Along a normal direction R of the mirror, the spatial 3D coordinates (Xᵥ, Yᵥ, Zᵥ) of the virtual images can be related to actual spatial 3D coordinates (X_{c}, Y_{c}, Z_{c}), which are computed as:

$${X}_{c} = {X}_{v} - \frac{2 {A}_{{i}_{m}} ( {A}_{{i}_{m}} {X}_{v} + {B}_{{i}_{m}} {Y}_{v} + {C}_{{i}_{m}} {Z}_{v} + {D}_{{i}_{m}} )}{{{A}_{{i}_{m}}}^{2} + {{B}_{{i}_{m}}}^{2} + {{C}_{{i}_{m}}}^{2}} \qquad ( 9 )$$

$${Y}_{c} = {Y}_{v} - \frac{2 {B}_{{i}_{m}} ( {A}_{{i}_{m}} {X}_{v} + {B}_{{i}_{m}} {Y}_{v} + {C}_{{i}_{m}} {Z}_{v} + {D}_{{i}_{m}} )}{{{A}_{{i}_{m}}}^{2} + {{B}_{{i}_{m}}}^{2} + {{C}_{{i}_{m}}}^{2}}$$

$${Z}_{c} = {Z}_{v} - \frac{2 {C}_{{i}_{m}} ( {A}_{{i}_{m}} {X}_{v} + {B}_{{i}_{m}} {Y}_{v} + {C}_{{i}_{m}} {Z}_{v} + {D}_{{i}_{m}} )}{{{A}_{{i}_{m}}}^{2} + {{B}_{{i}_{m}}}^{2} + {{C}_{{i}_{m}}}^{2}}$$

This process establishes a correspondence between (X_{c}, Y_{c}, Z_{c}) and P′(u, v) (shown in (b) of FIG. 6).

The positional association between the measured point P and its image pixel P′ is established using a pinhole camera model. This model facilitates accurate mapping of 3D spatial coordinates to their corresponding 2D image pixel coordinates, ensuring precise reconstruction of sectional contours.

This positional association can be expressed as:

$$s [ \begin{matrix}u \\ v \\ 1\end{matrix} ] = [ \begin{matrix}A & 0\end{matrix} ] [ \begin{matrix}{X}_{c} \\ {Y}_{c} \\ {Z}_{c} \\ 1\end{matrix} ] \qquad ( 10 )$$

wherein s represents a r andom scaling factor, and A is a 3×3 matrix of intrinsic parameters of the camera, which includes the effective focal length, camera sensor size, and main point. Equation (8) demonstrates that any space points along a line O_{c}P can be projected onto the same pixel location (P′) in the image. Furthermore, the 3D coordinate of the measured point P satisfies the equation of the laser plane expressed as:

$${A}_{i} {X}_{c} + {B}_{i} {Y}_{c} + {C}_{i} {Z}_{c} + {D}_{i} = 0 \qquad ( 11 )$$

wherein Aᵢ, Bᵢ, Cᵢ and Dᵢ are physical coefficients that describes the single laser plane equation. Considering that the camera model is an unrealistic linear imaging model, practical applications need to account for nonlinear distortions caused by manufacturing and installation errors. The relationship between the ideal laser point Pᵤ′(xᵤ, yᵤ) and the captured laser point P_{d}′(x_{d}, y_{d}) in the image coordinate system can be expressed as:

$${x}_{d} = {x}_{u} [ 1 + {k}_{1} ( {x}_{u}^{2} + {y}_{u}^{2} ) + {{k}_{2} ( {x}_{u}^{2} + {y}_{u}^{2} )}^{2} + {{k}_{3} ( {x}_{u}^{2} + {y}_{u}^{2} )}^{4} + {{p}_{1} ( 3 {x}_{u}^{2} + {y}_{u}^{2} )}^{2} + 2 {p}_{2} {x}_{u} {y}_{u} ] \qquad ( 12 )$$

$${y}_{d} = {y}_{u} [ 1 + {k}_{1} ( {x}_{u}^{2} + {y}_{u}^{2} ) + {{k}_{2} ( {x}_{u}^{2} + {y}_{u}^{2} )}^{2} + {{k}_{3} ( {x}_{u}^{2} + {y}_{u}^{2} )}^{4} + {{p}_{2} ( 3 {x}_{u}^{2} + {y}_{u}^{2} )}^{2} + 2 {p}_{1} {x}_{u} {y}_{u} ] \qquad ( 13 )$$

wherein coefficients k₁, k₂, k₃ correspond to radial distortion of the camera, while p₁, p₂ represent tangential distortion coefficients.

Three segment laser stripes are converted into point clouds using the established image model. Sectional profiles can be generated by point cloud post-processing (such as point cloud denoising, point cloud superimposition, etc.).

### 3. Measurement Experiments

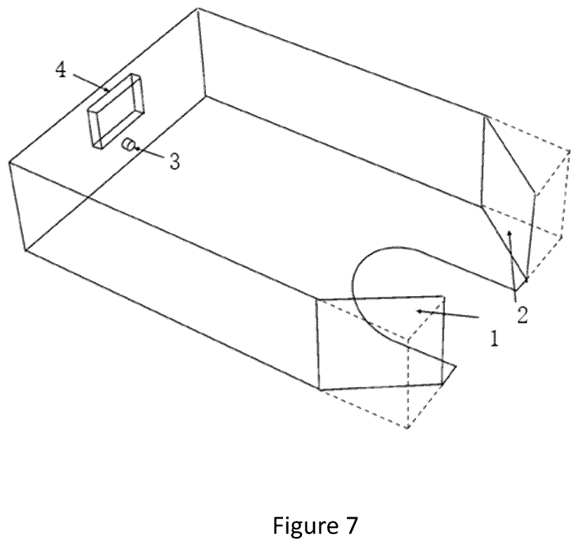

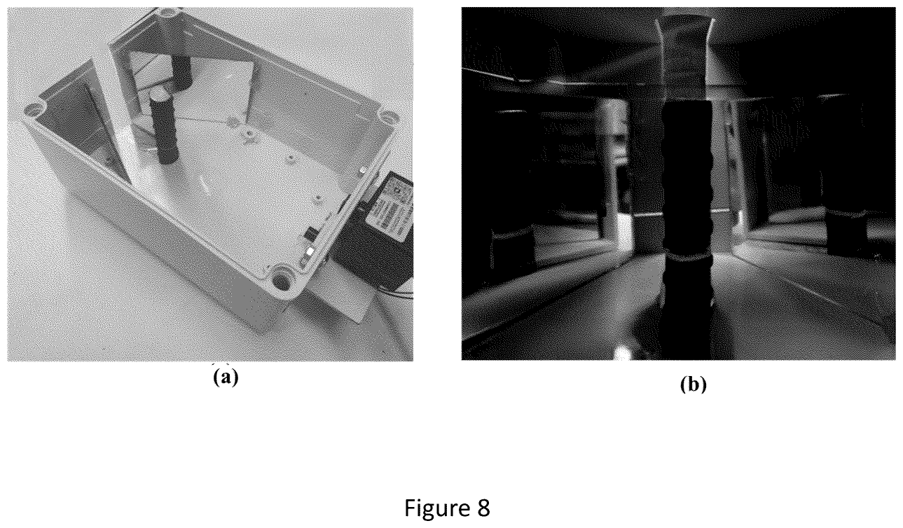

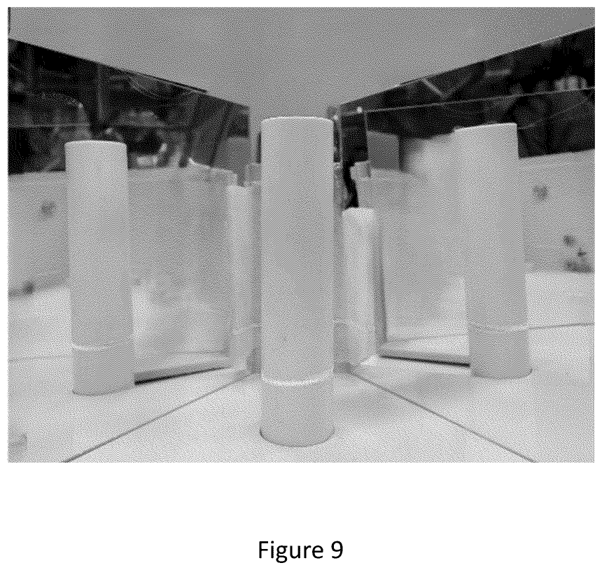

The system was implemented and tested in laboratory and field setting. FIGS. 7 and 8 illustrate the experimental setup. Specifically, (a) of FIG. 8 presents an external view of the equipment, while (b) of FIG. 8 displays an internal perspective view captured through internal imaging, and Table 2 lists detailed specifications for each component of the experimental setup. The system can be engineered to fulfill requirements of building scanning, thereby enabling accurate measurements within a range of 10 mm to 2 m. The device is equipped with distinct measurement ranges, thereby allowing different target objects within each range to have their sectional contours measured using a corresponding measurement apparatus. This modular configuration ensures versatility and precision in capturing geometrical profiles of various structural elements, thereby enhancing overall efficiency and reliability of a scanning process. Table 3 details each measurement range, along with corresponding object dimensions applicable to that range. A 3D measurement program was implemented using Python, running on a computer with an Intel i7-6700, 3.40 GHz CPU and 16 GB RAM. To ensure accuracy and reliability of experimental outcomes, a standard cylinder (diameter 20 mm) was utilized for validation purposes, as illustrated in FIG. 9. This standard cylinder serves as a benchmark to corroborate measurements and computational predictions derived from the experimental setup. An implementation process first includes performing calibration on the camera, mirrors, and laser plane, and subsequently placing the target object to be measured into the laser scanning apparatus.

The calibration step is critical for establishing a precise measurement model. It involves determining the intrinsic parameters of the camera (including focal length, principal point, and distortion coefficients) and the extrinsic parameters (relative rotation and translation matrices) that define the spatial relationship between the camera, the plane of the single-line laser, and the planes of the mirrors. Calibration may be performed using a standard calibration target, such as a checkerboard pattern or a reference cylinder of known dimensions, placed within the measurement volume. The image processing unit utilizes these calibrated parameters to accurately transform the 2D pixel coordinates of the virtual images observed in the mirrors back into real-world 3D spatial coordinates on the non-exposed surfaces of the target object.

A beam emitted by the laser diode directly illuminates a front surface (exposed surface) of the cylinder and is projected onto two inclined rear surfaces (two non-exposed surfaces) through mirror reflection. The camera photographs the exposed surface and virtual images of the two non-exposed surfaces reflected in the mirrors to capture distortion of a single laser line on three uneven surfaces. The image photographed by the camera is processed by an RLL algorithm to reconstruct point clouds of three segments of laser (specifically, including performing correction on the distortion; using the U-Net model to segment the laser stripe from the image after correction; using the Steger algorithm to extract the sub-pixel center of the laser stripe; aggregating sub-pixel centers of the laser stripe to generate a 3D point cloud), and subsequently fitted cylindrical profile information is obtained through point cloud post-processing (e.g., extracting the sectional profile from the 3D point cloud by 3D point cloud denoising, superimposing 3D point clouds, etc. to reconstruct the sectional profile of the target object). An equivalent circular diameter obtained by fitting arc segment data points is 20.07 mm, which has an error less than 0.1 mm compared with a true diameter (20 mm) of the standard cylinder, proving measurement accuracy of the present method.

TABLE 2
Parameters of hardware instruments

| Components | Specifications | Properties | |
|---|---|---|---|
| Camera | Model | Sony IMX586 | |
| | Sensor type | 12.7 × 12.7 mm (1/2.3″) CMOS | |
| | Focus length | 3.3 | mm |
| | Resolution (H × V) | 8000 × 6000 | |
| | Focal length | 3.3 | mm |
| Laser diode | Model | LQB-650-0.4 mW- Red laser | |
| | | line emitters | |
| | Dimensions of laser | ∅9 × 21 | mm |
| | head | | |
| | Linewidth@3 m | 635 | μm |

| | |
|---|---|
| Projection angle | 120° |

TABLE 3
Measurement range with corresponding object

| Measurement range | |
|---|---|
| (Equivalent circular | |
| diameter D) | Corresponding object |
| Class 1 | PVC Pipe, Steel Pipe, Aluminum Rod, Power Cable, |
| 10 mm-40 mm | Industrial Rope, Drive Shaft, Wheel Axle, Bolt, Stair |
| | Railing, Lamp Pole, and so on |
| Class 2 | Industrial Main Pipeline, Drainage Pipe, Gas Pipeline, |
| 40 mm-100 mm | Large Power Cable, Urban Street Drainage Pipe, and |
| | so on |
| Class 3 | Large Lighting Pole, Urban Main Drainage Pipe, Large |
| 100 mm-200 mm | Air Conditioning Duct, Industrial Main Pipeline, |
| | Building Main Column, and so on |
| Class 4 | Large Structural Column, Bridge Pier, Transmission |
| 200 mm-500 mm | Tower, Large Chimney, Industrial Storage Tank |
| | Support, Marine Buoy, Satellite Antenna Support, and |
| | so on |
| Class 5 | Industrial Storage Tank Support, Monument Column, |
| 500 mm-1000 mm | Marine Buoy, Architectural Decorative Column, Port |
| | Crane, Sports Facility Support Structure, and so on |
| Class 6 | Large Hydroelectric Turbine Framework, Large |
| 1000 mm-2000 mm | Underground Mine Shaft, Large Exhibition Hall |
| | Structural Support, and so on |

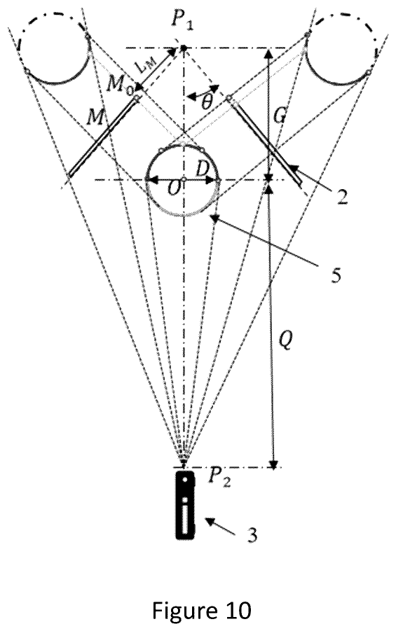

As shown in FIG. 10, it is essential to define the positions of intersection points P₁ and P₂ along extended lines of the mirrors, specifically the distance from 5 these points to the center of the target object, distance G between the point P₁ and the center O of the target object, and distance Q between the center O of the target object and the point P₂. In addition, the angle θ between the mirrors and the line segment P₁P₂ must be determined, as this angle θ is significant for accurate profile measurement. Prior to initiating a measurement process, an operator must conduct an initial evaluation to approximate an equivalent 10 diameter range category (6 classes in total) of the target object. A standardized criterion has been established whereby the laser must illuminate at least 75% of the entire section to enable accurate determination of the sectional contour using the algorithm. Under this standard (i.e., the laser illuminates at least 75% of the entire section), the permissible range of mirror angles corresponding to each specific measurement range has been determined, as detailed in Table 4.

TABLE 4
Measurement range and corresponding mirror angle range

| | G | | | | |
|---|---|---|---|---|---|
| Q | 1Dₘₐₓ | 1.5Dₘₐₓ | 2Dₘₐₓ | 2.5Dₘₐₓ | 3Dₘₐₓ |
| 1Dₘₐₓ | | | 26°-40° | 17°-50° | 11°-54° |
| 1.5Dₘₐₓ | | 27°-54° | 19°-60° | 15°-64° | 10°-66° |
| 2Dₘₐₓ | | 25°-61° | 18°-66° | 14°-70° | 9°-73° |
| 2.5Dₘₐₓ | 45°-60° | 23°-66° | 18°-72° | 14°-74° | 9°-75° |
| 3Dₘₐₓ | 42°-65° | 23°-70° | 18°-74° | 14°-76° | 9°-78° |
| 3.5Dₘₐₓ | 41°-69° | 23°-72° | 18°-76° | 14°-78° | 8°-80° |
| 4Dₘₐₓ | 40°-71° | 22°-74° | 18°-78° | 14°-80° | 8°-81° |
| 4.5Dₘₐₓ | 39°-73° | 22°-76° | 18°-80° | 14°-81° | 8°-82° |
| 5Dₘₐₓ | 39°-73° | 22°-76° | 18°-81° | 14°-82° | 8°-82° |

A slash “\” in Table 4 indicates that no angle range under corresponding Q values and G values is satisfying the standard (laser illuminating at least 75% of the entire section). To prevent the target object from being subjected to multiple projections between mirrors, which can adversely affect image recognition, and to ensure that the target object is smoothly inserted into the laser scanning apparatus, positioning of an initial point of the mirror is critically important. Specifically, upon determining the appropriate mirror angles, initial position of the mirror satisfies the following conditions:

$${L}_{M} ( G - \frac{{D}_{max}}{2} ) cos θ \qquad ( 14 )$$

wherein the extended line of the connecting line between the center of the target object and the center of the single-line laser intersects with the extended line of the mirror at point P₁, L_{M} represents the distance between point P₁ and the initial point Moof the mirror M (the distance between the initial point Moon the end of the mirror M closer to point P₁, i.e., L_{M} represents the distance between point P₁ and the end of the mirror M closer to point P₁), e represents the included angle between the extended line of said connecting line and the extended line of the mirror, and Dₘₐₓ represents the maximum equivalent circular diameter of the target object.

The system proposed in the embodiments of the present invention has the following advantages:

(1) Efficient and novel. Current scanners are limited to capturing contour dimensions of exposed surfaces. The system proposed by the present invention overcomes this limitation by incorporating mirrors that reflect the laser onto non-exposed surfaces, thereby enabling measurement of their contour dimensions. In addition, existing 3D scanning instruments are unable to effectively reconstruct dimensional parameters of target objects through mirror reflections. The method of the present invention offers significant advantages in mirror-based reflection measurements, thereby enhancing capability to capture comprehensive surface profiles.

(2) Handy and flexible. By utilizing a single laser line instead of multiple laser lines, the device maintains a simple and compact structure. The streamlined design facilitates handheld scanning, and can be used together with a handheld positioning rod, with the length of the handheld positioning rod being adjustable to allow flexible measurement of various object profiles (e.g., rebar embedded in ceiling concrete, irregularly shaped cups, or even tree trunks).

To enable such flexible measurement, the system is preferably constructed as a handheld portable device where the single-line laser, the mirrors, and the camera are rigidly fixed relative to each other within a housing or on a rigid frame. This rigid fixation ensures that the calibration remains valid while the device is moved. Furthermore, the system may comprise a handheld positioning rod connected to the housing. The length of this positioning rod may be adjustable (e.g., telescopic) to allow an operator to manually position the scanning apparatus over a target object that is otherwise out of reach, such as rebar located high in a ceiling. The connection between the rod and the housing may also include a rotation mechanism, allowing the operator to adjust the incidence angle of the laser to align it perpendicularly with the target object's axis.

(3) Robust, safe, and cost-effective. The algorithm integrates machine learning into the image processing pipeline to accurately locate the object's surface, extract the center of the laser stripe, and minimize errors induced by image distortion. Compared with vision-only systems such as stereo vision systems, the proposed algorithm demonstrates superior capability in handling texture-less surfaces. Components utilized in the system, including consumer-grade digital cameras and line lasers, are both affordable and readily accessible. Furthermore, the system ensures safety by employing Class I lasers, which are completely harmless to the human body. The approach of the present invention presents a more cost-effective alternative to high-precision 3D laser scanners, thereby making advanced scanning technology accessible for a wider range of applications.

The above content is a further detailed description of the present invention in conjunction with specific/preferred embodiments, and it should not be considered that specific implementation of the present invention is limited to these descriptions. For those of ordinary skill in the technical field to which the present invention belongs, several substitutions or variations can also be made to these described embodiments without departing from the inventive concept of the present invention, and these substitutions or variations should all be regarded as falling within the protection scope of the present invention. In the description of this specification, descriptions referring to terms “one embodiment”, “some embodiments”, “preferred embodiment”, “example”, “specific example”, or “some examples”, etc. mean that specific features, structures, materials, or characteristics described in conjunction with the embodiment or example are included in at least one embodiment or example of the present invention. In this specification, schematic representations of the above terms do not necessarily refer to the same embodiment or example. Moreover, the described specific features, structures, materials, or characteristics may be combined in any one or more embodiments or examples in a suitable manner. Without mutual contradiction, those skilled in the art can combine and assemble different embodiments or examples described in this specification and features of different embodiments or examples. Although embodiments of the present invention and their advantages have been described in detail, it should be understood that various changes, substitutions, and alterations can be made herein without departing from the protection scope of the patent application.

1. A system for automatically measuring a sectional profile of an object, comprising:
a single-line laser configured to emit a single laser line;
at least one mirror configured to reflect the laser line onto at least one non-exposed surface of a target object to be measured;
a camera configured to capture distortion of the laser line projected onto a surface of the target object; and
an image processing unit configured to process the distortion captured by the camera to generate sectional profile of the target object.

2. The system according to claim 1, wherein the target object comprises three uneven surfaces, with the three uneven surfaces being an exposed surface, a first non-exposed surface, and a second non-exposed surface respectively;
the mirror comprises a first mirror and a second mirror, wherein the first mirror corresponds to the first non-exposed surface such that the first non-exposed surface forms a first virtual image in the first mirror and the second mirror corresponds to the second non-exposed surface such that the second non-exposed surface forms a second virtual image in the second mirror;
the laser line emitted by the single-line laser projects directly onto the exposed surface and projects onto the first non-exposed surface via the first mirror and projects onto the second non-exposed surface via the second mirror;
the camera is configured to capture the exposed surface, the first virtual image and the second virtual image so as to capture the distortion of the laser line projected onto the three uneven surfaces;
the image processing unit is configured to reconstruct the 3D profile of each surface based on the distortion and superimpose laser profiles of the three uneven surfaces thereby generating a complete sectional profile of the target object.

3. The system according to claim 2, wherein the laser line emitted by the single-line laser projects directly onto the exposed surface to form a third laser arc length on the exposed surface and projects onto the first non-exposed surface via the first mirror to form a first laser arc length on the first virtual image and projects onto the second non-exposed surface via the second mirror to form a second laser arc length on the second virtual image; the camera is configured to capture the first laser arc length, the second laser arc length and the third laser arc length; and the image processing unit is configured to superimpose arc lengths of the three laser arc lengths thereby generating the complete sectional profile of the target object.

4. The system according to claim 2, wherein the first mirror and the second mirror are positioned on oblique rear sides of the target object to form a V-shaped configuration relative to the target object such that the camera captures the exposed surface and the virtual images of the first and second non-exposed surfaces in a single image frame without rotating the system around the target object.

5. The system according to claim 1, wherein a light source of the single-line laser is a laser diode.

6. The system according to claim 1, wherein: the single-line laser and the camera are aligned along the same vertical axis.

7. The system according to claim 1, wherein the single-line laser, the mirror and the camera are rigidly fixed relative to each other.

8. The system according to claim 1, further comprising a rod configured to rigidly mount the single-line laser, the mirror and the camera.

9. The system according to claim 1, wherein: the image processing unit comprises:
a distortion correction module configured to perform correction on the distortion;
an image segmentation module configured to segment a laser stripe from an image after correction;
a stripe center extraction module configured to extract a sub-pixel center of the laser stripe;
a 3D point cloud generation module configured to aggregate sub-pixel center of the laser stripe to generate a 3D point cloud; and
a sectional profile reconstruction module configured to extract sectional profile from the 3D point cloud.

10. The system according to claim 9, wherein the 3D point cloud generation module is configured to calculate real-world spatial coordinates of the non-exposed surface by determining an intersection point between vector of the camera and a plane of the mirror and applying a reflection symmetry transformation to the sub-pixel center of the laser stripe.

11. The system according to claim 1, wherein: a placement position of the mirror satisfies following condition:
$${L}_{M} \geq \frac{{D}_{max}}{2 sin θ}$$
wherein an extended line of a connecting line between a center of the target object and a center of the single-line laser intersects with an extended line of the mirror at a point P₁, L_{M} represents the distance between the point P₁ and an initial point of the mirror M, θ represents an included angle between the extended line of the connecting line and the extended line of the mirror, and Dₘₐₓ represents a maximum equivalent circular diameter of the target object.

12. The system according to claim 1, wherein the target object is a reinforcement bar partially embedded in a concrete structure.

13. A method for automatically measuring a sectional profile of an object, wherein the method comprises the following steps:
S1. emitting a single laser line using a single-line laser;
S2. reflecting the laser line onto at least one non-exposed surface of a target object to be measured via at least one mirror;
S3. capturing distortion of the laser line projected onto a surface of the target object using a camera; and
S4. processing the distortion captured by the camera via an image processing unit to generate sectional profile of the target object.

14. The method according to claim 13, further comprising the following step of: positioning the at least one mirror relative to the target object such that the single laser line illuminates at least 75% of the entire section of the target object.

15. The method according to claim 13, further comprising, prior to step S1, the following calibration step of: determining a relative spatial position and orientation of the camera, the single-line laser, and the at least one mirror to establish a measurement model for correlating 2D pixel coordinates of the camera to 3D spatial coordinates.

16. The method according to claim 13, wherein step S4 comprises:
S41. performing correction on the distortion;
S42. segmenting a laser stripe from an image after correction;
S43. extracting a sub-pixel center of the laser stripe;
S44. aggregating sub-pixel center of the laser stripe to generate a 3D point cloud; and
S45. extracting sectional profile from the 3D point cloud.

17. The method according to claim 16, wherein step S42 uses a U-Net model to segment the laser stripe; step S43 uses a Steger algorithm to extract the sub-pixel center of the laser stripe; and step S45 reconstructs the sectional profile of the target object through 3D point cloud post-processing.

18. The method according to claim 16, wherein step S44 comprises the following steps of:
defining a normal vector of the at least one mirror;
calculating a direction vector from the camera to an observed laser point on the mirror;
determining an intersection point between the direction vector and a plane of the mirror; and
calculating an actual position of the laser point on the non-exposed surface using reflection symmetry based on the intersection point and the normal vector.

19. The method according to claim 16, wherein step S45 comprises the following step of:
applying a minimization algorithm to optimize an alignment of the 3D point cloud derived from the exposed surface and the 3D point cloud derived from the non-exposed surface to minimize residual errors between a modeled profile and empirical data points.

20. A non-transitory computer-readable medium storing computer-readable instructions for a system for automatically measuring a sectional profile of an object, wherein the storing computer-readable instructions, when executed by a processor of the system, cause the processor to:
emit a single laser line using a single-line laser;
reflect the laser line onto at least one non-exposed surface of a target object to be measured via at least one mirror;
capture distortion of the laser line projected onto a surface of the target object using a camera; and
process the distortion captured by the camera via an image processing unit to generate sectional profile of the target object.
